(19) United States
(12) Patent Application Publication
(10) Pub. No.: US 2016/0007047 A1
(43) Pub. Date: Jan. 7, 2016

(54) METHOD OF CONTROLLING BANDWIDTH IN AN ALWAYS ON VIDEO CONFERENCING SYSTEM

(71) Applicant: Magor Communications Corporation, Ottawa (CA)

(72) Inventor: Mojtaba HOSSEINI, Ottawa (CA)

(21) Appl. No.: 14/790,988

(22) Filed: Jul. 2, 2015

Related U.S. Application Data
(60) Provisional application No. 62/021,081, filed on Jul. 4, 2014.
(60) Provisional application No. 62/033,895, filed on Aug. 6, 2014.

(51) Int. Cl. H04N 19/87; H04N 7/15

(52) U.S. Cl. CPC H04N 19/87; H04N 7/15

(57) ABSTRACT

Disclosed is a video conferencing endpoint comprising a camera interface for receiving local video from a local camera, a video encoder for encoding the local video from the camera interface for transmission to a remote endpoint over a communications channel, a feature detector for determining whether a feature is present in the local video received from the local camera, and a transmit parameter controller operative to control the video encoder to change at least one transmit parameter in response to at least one of: the presence or absence of the feature in the received local video, and a signal received from a remote endpoint indicating the presence or absence of a feature in the video acquired at the remote endpoint.

### CROSS REFERENCE TO RELATED APPLICATION

This application claims the benefit under 35 USC 119(e) of U.S. Provisional Application Nos. 62/021,081 filed Jul. 4, 2014 and 62/033,895 filed Aug. 6, 2014, the contents of which are incorporated by reference herein.

### FIELD OF THE INVENTION

This invention relates to the field of video conferencing, and in particular to a method of controlling bandwidth in an always on video conferencing system.

### BACKGROUND OF THE INVENTION

With the increased availability of low cost hardware capable of providing a video conference or telepresence endpoint, users are extending the application of video beyond its original purpose of a formal meeting to a conceptual “digital water cooler” or “virtual (bi-directional) window”. This means that the video connections and devices are left in an “always-on” mode so that when a person looks at a display screen it is already showing activity at a distant location.

The context of the present invention is two-way video conference equipment and, especially, multi-point bi-directional video conference equipment, employed in sessions that are permanently or semi-permanently left open. When people finish communicating they simply walk away. A typical configuration of such equipment is illustrated in FIG. 1 and is identical to the configuration of video conference equipment. Endpoints 104, 110 and 116 are interconnected via a network, e.g. an IP network like the Internet, using physical connections 107, 113 and 119, which may comprise wired and/or wireless links.

Each endpoint comprises one of more video cameras, display screens, microphones and loudspeakers.

In one connection configuration, known as a mesh configuration, virtual connections (e.g. IP connections within the physical connections) between endpoints are point to point, i.e. endpoint 104 has two, bi-directional video connections, one bi-directional connection to endpoint 110 and one to endpoint 116; and so on, so that each endpoint is connected by a bi-directional connection to each other endpoint.

When endpoints are configured in a mesh in which the total number of bi-directional connections dramatically increase with the number of endpoints (n) according to the formula {n(n−1)/2}.

Although Internet connections with sufficient bandwidth are increasingly common, making the always-on concept practical, devices frequently connect via a wireless network on which bandwidth may be either expensive or limited or both.

The concept of spontaneous or always-on video has been known for a considerable period of time and expensive “nailed” up connections have been employed. Such an concept was arguably first described in a DARPA Technical Report “DDI/IT 83-4-314.73”, Linda B. Allardyce and L. Scott Randall, April 1983.

A description of always-on video in its present meaning and outlining the associated human factors can be found at http://newsroom.intel.com/docs/DOC-2151 “The idea is quite simple: If both contacts look into the camera the conference is established. If they ignore the camera the picture becomes blurred, the audio interrupts and the conference pauses or ends.” “A person who does not pay attention to the video conferencing system is just blurred (left picture). The right picture shows the video's depth information including the head of a conference attendee who looks away (white cross).”

Perch http://perch.co/ delivers an always-on video service. “Perch is an always-on video connection for the people you talk to every day. Setting up Perch in your home office will let you easily stay in contact with the people in your life. Because Perch is always ready, it's simpler and more straightforward than other communication solutions.” . . . “Perch anticipates intent to talk and activates the microphone when you're ready”.

Somewhat related, US20140028785 teaches a method of communicating information exchanged in a video conference in which greater bandwidth is allocated to the ‘primary presenter’ than is to other participants.

### SUMMARY OF THE INVENTION

According to the present invention there is provided a video conferencing endpoint comprising a camera interface for receiving local video from a local camera; a video encoder for encoding the local video from the camera interface for transmission to a remote endpoint communications channel; a feature detector for determining whether a feature is present in the local video received from the local camera; and a transmit parameter controller operative to control the video encoder to change at least one transmit parameter in response to at least one of: the presence or absence of the feature in the received local video, and a signal received from a remote endpoint indicating the presence or absence of a feature in local video acquired at the remote endpoint.

Typically, the feature is the face or eye, but other features characteristic of the presence of a person, such as the outline of an upper torso, could be employed.

Embodiments of the invention thus employ region of interest, especially face, or eye, detection technology at each endpoint of a video conference configured with always-on connections. Video from a camera broadly capturing anyone looking at the associated screen is processed indicating whether one or more faces is facing the screen or not.

In the event that no one is looking at the screen (case 1) the transmitted video encoder is set to transmit video at a low bandwidth. In an enhancement of this basic implementation (case 2), the source of the video camera (source A) that has determined existence or non-existence of face(s) in its video in case 1, can transmit this information as ROI metadata to the receiver (receiver B), for example using a SIP (Session Initiation Protocol). The receiver in the context of this application (multi-way bidirectional persistent video), is itself a sender of video (source B) to A. Source B can use the fact that there is no one at A, as indicated by the ROI metadata, to reduce its bandwidth by dropping resolution, bitrate or frame rate, thereby reducing bi-directional traffic (case 1 only reduce one-way video traffic).

In Case 2, the most important embodiment of the invention, source B may have faces detected (i.e. there are active participants in B) but still there is no need to send full quality video to A since there is no one in A to view it.

In a further aspect of the invention cases 1 and 2 are combined such that full quality video is only transmitted between A and B (and vice versa) when there are faces present in video at both A and B.

In another case (case 3), the ROI metadata is used to minimize resource consumption at receiver B on the basis of the region(s) of interest at source A. For example and of particular importance on mobile devices, reducing any or all of: cpu cycles, memory used, or screen area consumed. This can be achieved by the user choosing an option to crop received video to display only the region of interest detected at the source.

The invention may be easily adapted in the case of endpoint(s) locations having always-on connections to multiple endpoint locations (e.g. a multi-party conference configuration).). In Case 3 user option settings may differ at each endpoint.

An important feature of the invention is that during periods when it is determined that full quality video quality is not required video bandwidth is substantially reduced by reducing video quality in ways which do not significantly impact local awareness of activity in the remote location(s). This may be accomplished by substantially adjusting any or all digitization and encoding parameters (i.e. resolution, bitrate or frame rate). For example, by reducing frame rate to less than one frame per second and reducing bitrate so that details are somewhat blurred.

As a result, communications costs can be substantially reduced, the quality of audio and video in active sessions may be considerably improved by using higher bandwidth when needed, and the performance of unrelated applications sharing the network connection used by the endpoint may be substantially improved.

According to another aspect of the invention there is provided a video conferencing system comprising a pair of endpoints in communication with each other over a bi-directional communications channel, each endpoint comprising: a camera interface for receiving local video from a local camera; a video encoder for encoding the local video from the camera interface for transmission to a remote endpoint over a communications channel; a feature detector for determining whether a feature is present in the local video received from the local camera; and a transmit parameter controller operative to control the video encoder to change at least one transmit parameter in response to at least one of: the presence or absence of the feature in the received local video, and a signal received from a remote endpoint indicating the presence or absence of a feature in the video acquired at the remote endpoint.

In yet another aspect the invention provides a method of controlling bandwidth in an always on video conferencing system comprising a pair of endpoints in communication with each other over a bi-directional communications channel, the method comprising: reducing bandwidth of the video transmitted over the communications channel in response to absence of the feature in the received local video, and a signal received from a remote endpoint indicating the absence of a feature in the video acquired at the remote endpoint.

A further aspect of the invention provides a video conferencing endpoint comprising a camera interface for receiving local video from a local camera; a video encoder for encoding the local video from the camera interface for transmission to a remote endpoint over a communications channel; a region-of interest detector for identifying a region-of-interest in the local video received from the local camera; and a video controller operative to transmit metadata containing the coordinates of the region-of-interest to a remote endpoint.

A still further aspect of the invention provides a video conferencing endpoint comprising: a display; a module for accepting user settings; and a video controller operative to receive metadata containing the coordinates of a region-of-interest and responsive to user settings to display only the region-of-interest on the display.

### BRIEF DESCRIPTION OF THE DRAWINGS

The invention will now be described in more detail, by way of example only, with reference to the accompanying drawings, in which:—

FIG. 1 shows a typical prior art telepresence configuration;

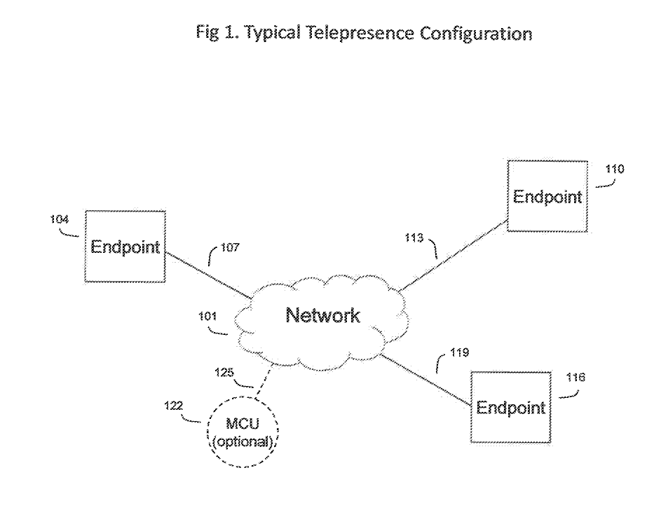

FIG. 2 shows a typical endpoint configuration in accordance with an embodiment of the invention;

FIG. 3 is a flow chart showing face detection for the remote only case; and

FIG. 4 is a flow chart showing face detection at both endpoints;

FIG. 5 shows another embodiment of the invention; and

FIG. 6 is a flow chart applicable to the FIG. 5 embodiment.

### DETAILED DESCRIPTION OF THE INVENTION

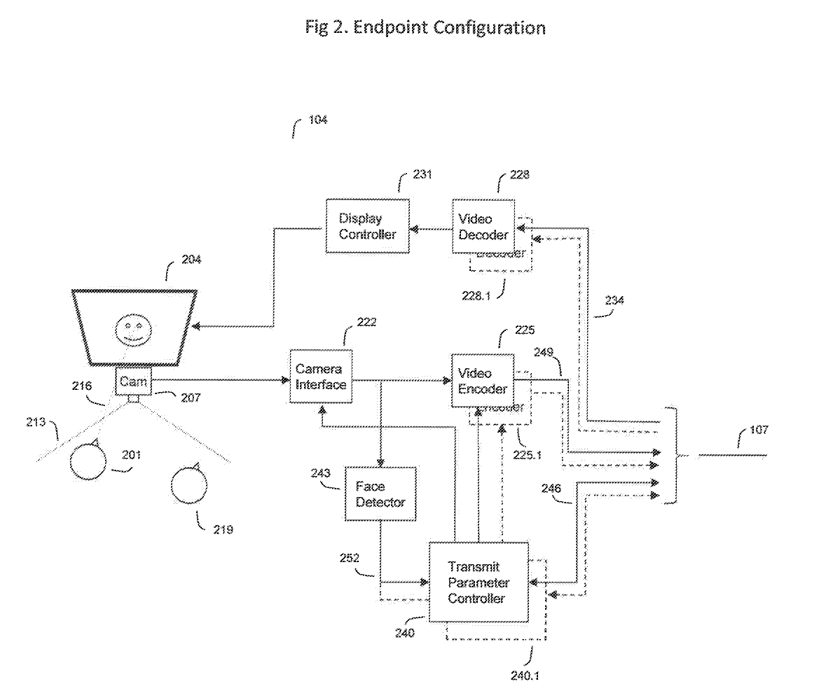

A typical video conference endpoint 104 is shown in block diagram form in FIG. 2.

A screen 204 and camera 207 are collocated. Preferably, as is typical in video conference for best eye contact of conferees, the camera and screen are horizontally centered and the camera sits just above or just below (illustrated case) the screen.

The camera has preferably a wide angle lens or, if it is adjustable, is set to a wide angle 213 so that most people 201 in the vicinity of the screen and interested in action at the remote location displayed on the screen will captured by the camera.

The video signal from the camera 207 via the Camera Interface 222 is distributed to both the Video Encoder (and transmitter) 225 and a Face/Eye Detector function 243.

The Camera Interface 222 and Video Encoder 225 are typical of those found in any video system except that certain parameters may be controlled by the transmit parameter controller 240, which receives inputs from the local face detector 243 and a remote face detector signal 246 from a face detector at a remote endpoint similar to that shown in FIG. 2. For example the transmit parameter controller 240 may signal the video encoder 225 and camera interface 222 to adjust any or all of video resolution, bitrate or frame rate.

Typically the remote face detector signal 246 will be adapted to utilize a known call control protocol e.g. SIP. That is to say, rather than a continuous signal, a message will be sent in the event of a change, e.g. indicating one of either ‘front of a face(s) has come into view’ or ‘no frontal faces now in view’ after a suitable de-bouncing period.

The local face/eye detector 243 processes the video signal from the local camera using known technology. It will indicate whether one or more individuals e.g. like individual 201 within its field of view is, more or less, looking at the screen or it will indicate that there are no individuals within its field of view facing the screen e.g. like individual 219.

The display components including video decoder (and receiver) 228, display controller 231 and display 204 are similar to those used in a typical video conference or telepresence system.

All of the functions of the endpoint with the likely exception of the camera and display may implemented as software running on a computer, in which case the functional blocks may correspond to software modules.

As noted earlier the invention is particularly suited to mesh configuration multi-point conferences. It will therefore be understood by one skilled in the art that the Network Connection 107 may include IP connections (i.e. bi-directional video and call control) to multiple other endpoints.

That is to say, and it is common practice, that there may be multiple call control connections 246, one connecting each distant endpoint to a local Transmit Parameter Controller (dotted for clarity) 240.1 (etc.).

For each additional endpoint, there may be a separate Video Encoder 225.1 (etc.) and transmitter that will be tuned based on its corresponding Transmit Parameter Control or in the case where the embodiment employs a scalable video codec, then a single Video Encoder but separate transmitters for each endpoint and the Transmit Parameter Control fine-tune the transmitter per endpoint (by deciding which scalability level to transmit for example).

Each Transmit Parameter Controller 240, 240.1 etc. will receive input from the common local Face Detector 243

Similarly there may be corresponding Receive Video signals in addition to signal 234 each having a Video Decoder 228.1 (etc.) in addition to video decoder 228. Multiple video signals may be combined in various know ways for presentation to a user(s) via one or more screens.

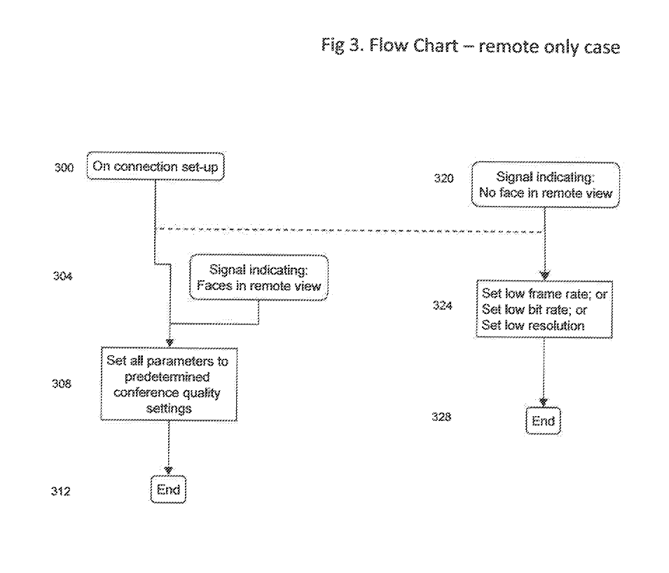

The Transmit Parameter Controller 240 will now be described in more detail with reference to flow charts in FIG. 3. This chart illustrates the core case in which video is controlled by presence of individuals at the remote location.

When the connection is initially set up 300 all parameters are set to those used for a regular bi-directional video call 308 to the particular endpoint e.g. HD quality. It will be necessary to sync with the remote endpoint to cover the case where no face is initially in view, shown dotted, using any known method.

In the event of a signal from the remote endpoint indicating no face is in the remote view 320 the Transmit Parameter Controller 240 will set one or more video digitization or encoding parameters to a value appropriate for the stand-by state 324.

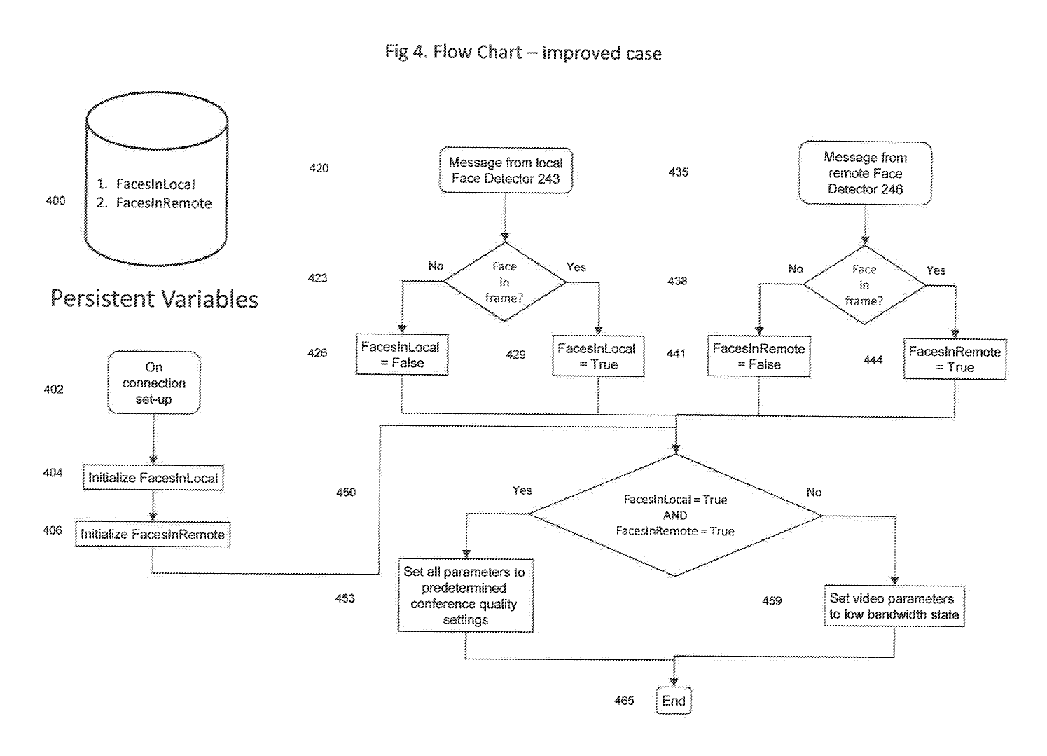

Note that this embodiment does not require the local Face/Eye Detector 243 In an alternative embodiment, see Flow Chart in FIG. 4, signals from both the local Face/Eye Detector 252 and the remote Face/Eye Detector 246 are employed.

In a typical event based implementation certain persistent variables 400 are maintained in local computer memory. FacesInLocal is True only if at least one person is detected more or less looking at the local screen. Similarly FacesInRemote is True only if at least one person is more or less looking at the remote screen. This could include cases where a face or eye is detected in a transient state for example ‘face somewhat or partially in view’.

When a connection is set up 402 the two variables are initialized. Because there may or may not be faces in view of either of both screens a method, which one skilled in the art would understand how to implement, 404 and 406 must follow.

The process then flows to the decision 450. If there is no one facing either the local screen or the remote screen, i.e. FacesInLocal==False or FacesInRemote==False then the novel step 459 is invoked and video bandwidth is substantially reduced using any or all methods described before. Or else there is someone facing the screen at both local and remote endpoints then video parameters are set to the value that would be used had the invention not been implemented 453.

As time passes individuals will come and go sometimes attracted by activity visible on the screens. Each time a person looks more or less directly at the screen, or moves away, messages will be sent by the associated face/eye detector.

Messages from the local Face/Eye Detector 243 invoke the process at 420. Depending on whether the message indicates that am individual is looking at the screen FacesInLocal will be set 429 or cleared 426. From here the process will apply the test at 450 described in the above paragraph following the same steps.

Similarly, messages from the remote Face Detector 246 will be processed 435 and result in the FacesInRemote variable being set 444 or cleared 441 after which this process also moves to step 450 as above.

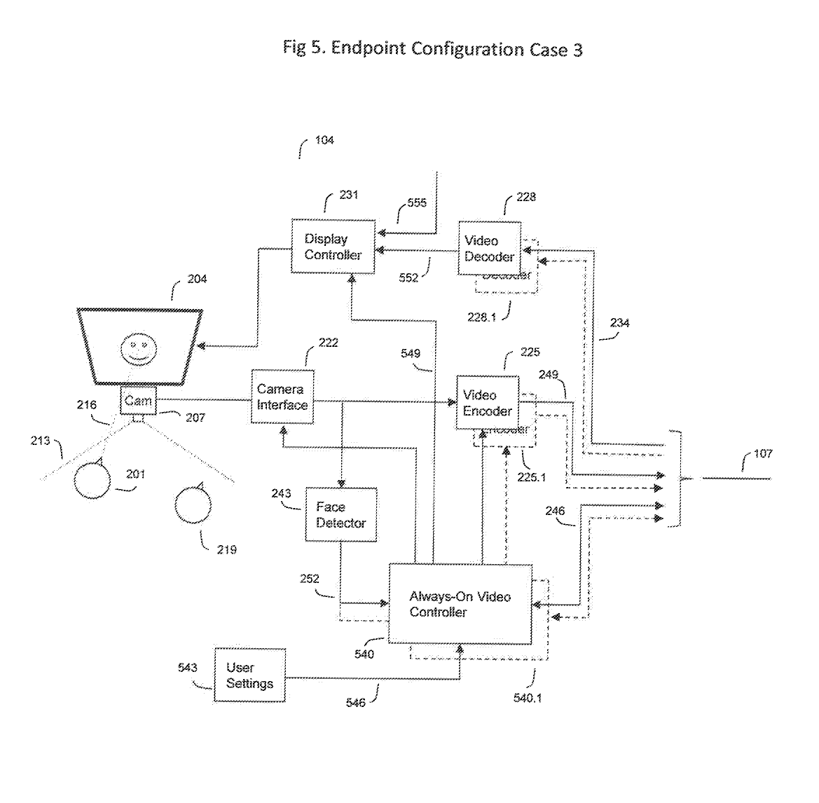

In a further embodiment to Always-On video connections, referring to FIG. 5, signal 252 from the Face Detector 243 further includes information about the geometric co-ordinates of the region(s) of interest. For example x1,y1 being the upper left and x2, y2 being the lower right respective corners of a ROI.

Always-On Video Controller 540 sends this co-ordinate meta data in call control connection(s) 246 to the distant endpoint(s) to which video stream(s) from camera 207 are being transmitted. The Always-On Video Controller 540 may include the functions of Transmit Parameter Controller 240.

Display Controller 231 renders multiple video streams and other typical computer display data 555 to the screen or screens 204. The following description covers the case of one particular video stream 552 from connection 234, one of possibly many, for which associated meta data has been received in message connection(s) 246.

A signal 549, typically a software protocol, from the Always-On Video Controller instructs the Display Controller 231 to crop video stream 552 to specified coordinates x1, y1-x2, y2, or to not crop the video.

In an embodiment of the invention a user may select whether or not regions of interest should be cropped or fully rendered and typically this will be a separate setting for each received video stream. Such setting could be implemented in many known ways, the following assumes such a setting for the particular video stream 234.

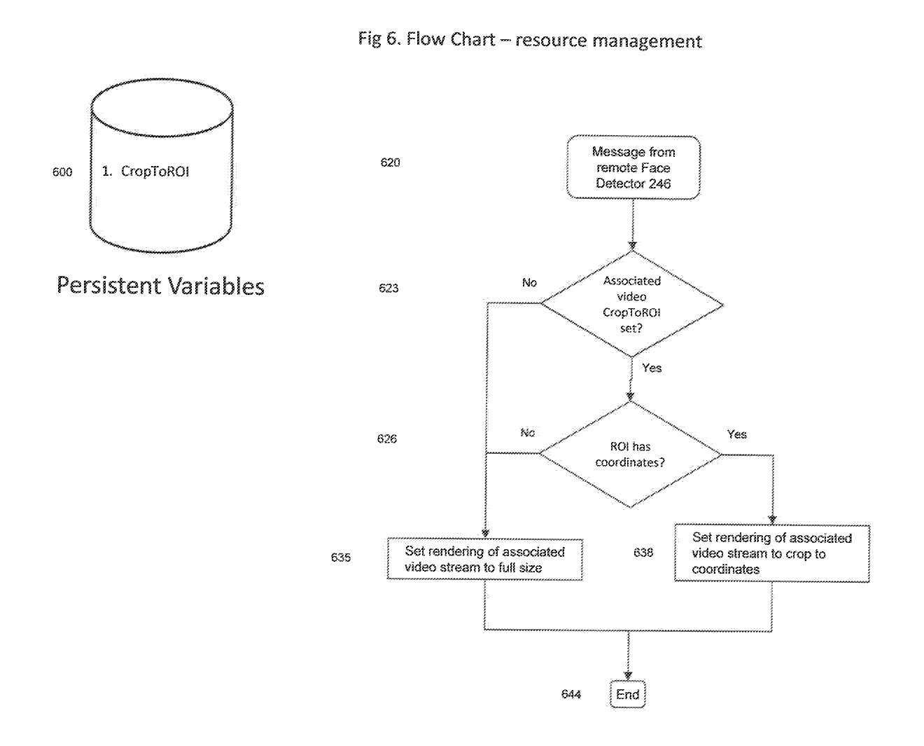

Operation of the added functions of the Always-On Video Controller 540 will be better understood from the flow chart in FIG. 6.

The flow chart shows the operations associated with a particular video stream 552 when a message associated with that video stream is received in connection 246.

Operation is controlled by a persistent variable, for example a user option, CropToROI 600 associated with the particular video stream 234. Of course this could also be a global setting.

When the message is received from the process begins 620.

At 623 if the CropToROI 600 variable is set to indicate that the steam should be cropped to the region of interest the process continues at 626.

At 626, if the message 620 contained the coordinates of the ROI (x1, y1-x2, y2) then the process continues to 638.

At 638 a signal is sent from Always-On Video Controller 540 to the Display Controller 231 indicating that the video stream 552 should be cropped to the specified coordinates (x1, y1-x2, y2) after which the process ends 644.

In the event at 626 that the message 620 does not contain coordinates, or in the event at 623 that the CropToROI 600 setting is set to no cropping, then the process continues at 635.

At 635 a signal is sent from Always-On Video Controller 540 to the Display Controller 231 indicating that the video stream 552 should not be cropped, after which the process ends 644.

As noted an endpoint embodying the invention is particularly suited to a mesh configuration conference, and the description has so far focused on this configuration, but at a different point in time could be effective in a star configuration. Such a configuration would employ a suitably adapted multipoint control unit (MCU) 122. Equipment used in more complex hybrid configurations may be similarly adapted.

1. A video conferencing endpoint comprising:
a camera interface for receiving local video from a local camera;
a video encoder for encoding the local video from the camera interface for transmission to a remote endpoint over a communications channel;
a feature detector for determining whether a feature is present in the local video received from the local camera; and
a transmit parameter controller operative to control the video encoder to change at least one transmit parameter in response to at least one of: the presence or absence of the feature in the received local video, and a signal received from a remote endpoint indicating the presence or absence of a feature in the video acquired at the remote endpoint.

2. A video conferencing endpoint as claimed in claim 1, wherein the transmit controller is operative to reduce the bandwidth of transmitted video in the absence of said feature in the local video.

3. A video conferencing endpoint as claimed in claim 1, wherein the transmit controller is operative to reduce the bandwidth of transmitted video upon receipt of a said signal from the remote endpoint indicating the absence of said feature in the video acquired at the remote endpoint.

4. A video conferencing endpoint as claimed in claim 1, wherein said communications parameter is selected from the group consisting of: the frame rate, the bit rate, the resolution, and a combination thereof.

5. A video conferencing endpoint as claimed in claim 4, which is configured to send metadata containing coordinates of a region-of-interest to the remote endpoint.

6. A video conferencing system comprising:
a pair of endpoints in communication with each other over a bi-directional communications channel, each endpoint comprising:
a camera interface for receiving local video from a local camera;
a video encoder for encoding the local video from the camera interface for transmission to a remote endpoint over a communications channel;
a feature detector for determining whether a feature is present in the local video received from the local camera; and
a transmit parameter controller operative to control the video encoder to change at least one transmit parameter in response to at least one of: the presence or absence of the feature in the received local video, and a signal received from a remote endpoint indicating the presence or absence of a feature in the video acquired at the remote endpoint.

7. A video conferencing system as claimed in claim 6, wherein the transmit controller in a first said endpoint is operative to reduce the bandwidth of transmitted video in the absence of said feature in the local video.

8. A video conferencing system as claimed in claim 6, wherein the transmit controller in a second said endpoint is operative to reduce the bandwidth of transmitted video in the absence of said feature in the video acquired at said second endpoint.

9. A video conferencing system as claimed in claim 6, wherein the transmit controller in a second said endpoint is operative to reduce the bandwidth of transmitted video in the absence of said feature in the video received from the first endpoint despite the presence of said feature in the video acquired at said second endpoint.

10. A video conferencing system as claimed in claim 6, wherein the transmit controller at each endpoint is operative to reduce the bandwidth of transmitted video the absence of said feature in the video acquired at the each endpoint.

11. A video conferencing system as claimed in claim 9, wherein said transmit parameter is selected from the group consisting of: the frame rate, the bit rate, the resolution, and a combination thereof.

12. A method of controlling bandwidth in an always on video conferencing system comprising a pair of endpoints in communication with each other over a bi-directional communications channel, the method comprising:
reducing bandwidth of the video transmitted over the communications channel in response to absence of the feature in the received local video, and a signal received from a remote endpoint indicating the absence of a feature in the video acquired at the remote endpoint.

13. A method as claimed in claim 12, wherein the bandwidth of video transmitted from an endpoint is reduced in the absence of said feature in the video acquired at that endpoint.

14. A method as claimed in claim 12, wherein the bandwidth of video transmitted from an endpoint is reduced in the absence of said feature in the video acquired at the other endpoint in communication therewith.

15. A method as claimed in claim 12, wherein the bandwidth of video transmitted from a local endpoint is reduced in the absence of said feature in the video acquired at the other endpoint in communication therewith even when said feature is present in the video acquired at said local endpoint.

16. A method as claimed in claim 12, wherein said communications parameter is selected from the group consisting of: the frame rate, the bit rate, the resolution, and a combination thereof.
